(19) United States
(12) Patent Application Publication
(10) Pub. No.: US 2020/0090128 A1
(43) Pub. Date: Mar. 19, 2020

(54) SYSTEMS AND METHODS FOR DETERMINING COMPLETION OF AND TRANSMITTING CAMPAIGN-RELATED CONTENT

(71) Applicant: ServiceNow, Inc., Santa Clara, CA (US)

(72) Inventors: Corey Daniel Leamon, Escondido, CA (US); Lucinda Kathryn Foss, San Francisco, CA (US); Robert Robles Wallace, Carlsbad, CA (US); Thomas Gerald O'Neill, San Diego, CA (US); Nicholas Lawrence, San Diego, CA (US)

(21) Appl. No.: 16/164,107

(22) Filed: Oct. 18, 2018

Related U.S. Application Data
(60) Provisional application No. 62/732,407, filed on Sep. 17, 2018.

(51) Int. Cl. G06Q 10/10; G06Q 10/06

(52) U.S. Cl. CPC G06Q 10/105; G06Q 10/063114

(57) ABSTRACT

The present approach relates to independently tracking individual progress of campaign-related activities part of a campaign respectively associated with a plurality of individuals. Embodiments disclosed herein include marking as complete a campaign-related activity in response to completion of the campaign-related activity by a first set of individuals, marking as incomplete an outstanding campaign-related activity in response to determining that a second set of individuals has not engaged with or completed the outstanding campaign-related activity, and then assigning subsequent campaign-related content to the individual based on whether the campaign-related activity was completed or not. For example, the second set of individuals who have not completed the campaign-related activity may each be sent a reminder notification, such as an email reminder, while the first set of individuals who have completed the campaign-related activity may receive a subsequent campaign-related content for completion.

### CROSS-REFERENCE TO RELATED APPLICATIONS

This application claims priority to U.S. Provisional Application No. 62/732,407, entitled “SYSTEMS AND METHODS FOR DETERMINING COMPLETION OF AND TRANSMITTING CAMPAIGN-RELATED CONTENT,” filed Sep. 17, 2018, the disclosure of which is herein incorporated by reference in its entirety for all purposes.

### BACKGROUND

The present disclosure relates generally to determining completion of and transmitting content targeted to individuals or groups. More specifically, the present disclosure includes determining completion of a campaign-related content requesting or requiring a respective individual to complete an action and, in response to determining the completion of the campaign-related content by the individual, assigning or providing subsequent campaign-related content to the individual who completed the task.

This section is intended to introduce the reader to various aspects of art that may be related to aspects of the present disclosure, which are described and/or claimed below. This discussion is believed to be helpful in providing the reader with background information to facilitate a better understanding the present disclosure. Accordingly, it should be understood that these statements are to be read in this light, and not as admissions of prior art.

An enterprise or organization may include different departments (e.g., human resources (HR), information technology (IT), accounting, and so forth) that may operate in different locations (e.g., cities, states, countries), and each department typically includes members having different roles (e.g., managers, assistants, associates, and so forth). The enterprise may disseminate content that may be characterized as being part of a campaign (e.g., an informational campaign, a sign-up campaign, an awareness campaign, a safety campaign, and so forth) to some or all of the individuals of the enterprise or organization. For example, such campaign related content may be associated with benefits, training, compensation, policy changes, insurance enrollment, and so forth, and may include elements to be completed or actions to be performed by certain individuals. Typically, an individual tasked with completing the campaign-related content may be reminded (e.g., sent an electronic reminder) at a date prior to a deadline to complete the task. However, some target individuals may have already completed the task, while others may not have completed the task. As such, it may be difficult to manage dissemination and monitoring of an ongoing campaign as different groups of participants may perform (or not perform) assigned tasks at different times.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present approach relates to systems and methods for determining completion of campaign-related activities and assigning subsequent campaign-related content in response to completion of the campaign-related activities. The present approach includes marking as complete a campaign-related activity in response to participant completion of the campaign-related activity and marking as incomplete an outstanding campaign-related activity in response to determining that a participant has not engaged with or completed the outstanding campaign-related activity. Furthermore, the present approach includes assigning subsequent campaign-related content to the participants based on whether the campaign-related activity was completed or not. For example, a participant who has not completed the campaign-related activity may be sent a reminder notification (e.g., reminder email), while another participant who has completed the campaign-related activity may receive subsequent campaign-related content, such as another campaign-related activity for completion, or a campaign item, such as an email thanking the participant for completing the campaign-related activity. In this manner, enterprises implementing the embodiments disclosed herein may better manage the personalized allocation of campaign-related content and track the completion/progress of campaign-related activity associated with such campaigns, such that progress of a campaign of one participant requiring completion of a campaign-related activity may be independent of progress of another participant also requiring completion of another or the same campaign-related activity.

### BRIEF DESCRIPTION OF THE DRAWINGS

Various aspects of this disclosure may be better understood upon reading the following detailed description and upon reference to the drawings in which:

FIG. 1 is a block diagram of an embodiment of a cloud computing system, in accordance with aspects of the present disclosure;

FIG. 2 is a block diagram of an embodiment of a multi-instance cloud architecture, in accordance with aspects of the present disclosure;

FIG. 3 is a block diagram of a computing device utilized in a computing system that may be present in FIG. 1 or 2, in accordance with aspects of the present disclosure;

FIG. 4 is a block diagram of an embodiment of a server system that may be associated with the distributed computing system of FIG. 1, in accordance with aspects of the present disclosure;

FIG. 5 is a flow diagram of an embodiment for assigning campaign-related content to an individual of an enterprise, in accordance with aspects of the present disclosure;

FIG. 6 is a flow diagram of steps performed in managing campaigns that include determining completion of a campaign-related activity and assigning subsequent actions, in accordance with aspects of the present disclosure;

FIG. 7 depicts an example of a list of campaign-related activities, in accordance with aspects of the present disclosure;

FIG. 8 depicts an example of a detail view of an initial campaign-related activity, in accordance with aspects of the present disclosure;

FIG. 9 depicts an example of a detail view of a subsequent campaign-related activity, in accordance with aspects of the present disclosure;

FIG. 10 depicts an example of the initial campaign-related activity of FIG. 8 requiring an action, selecting a button, for completion, in accordance with aspects of the present disclosure;

FIG. 11 depicts an example of the subsequent campaign-related activity of FIG. 9 requiring another action, selecting a link, for completion, in accordance with aspects of the present disclosure;

FIG. 12 depicts an example of the initial campaign-related activity of FIG. 8 requiring another action, viewing a video, for completion, in accordance with aspects of the present disclosure;

FIG. 13 depicts an example of a another subsequent campaign-related activity requiring another action, completing a checklist, for completion, in accordance with aspects of the present disclosure;

FIG. 14 depicts an example of a create window for creating a campaign-related activity, in accordance with aspects of the present disclosure; and

FIG. 15 depicts an example of a scheduling window for specifying a schedule associated with the created campaign-related activity of FIG. 14, in accordance with aspects of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. In some embodiments, the computing system may employ any suitable circuitry, such as a processor-based device, memory devices, storage devices, and the like. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

Furthermore, as used herein a “campaign” refers to a planned and coordinated dissemination of informational and/or actionable content to select users (i.e., “campaign participants” or “participants” as used herein) of an organization. Hence, a campaign as used herein may include, but is not limited to, an informational campaign, a sign-up campaign, an awareness campaign, a safety campaign, and so forth, in which some or all of the individuals of an organization receive information and/or tasks in a coordinated or sequential manner. As used herein, “campaign items” relate to pre-configured or pre-determined campaign-related content (e.g., information) pushed (e.g., sent) out to individuals of an organization (e.g., an enterprise) or a subset of the individuals via various content channels (e.g., web, email, instant messaging (IM), etc.) in response to specified trigger events, such as events related to employment dates or anniversaries, organizational deadlines or target dates (e.g., open benefits enrollment for an insurance plan), calendar-based events, holidays, life events (e.g., birthdays, anniversaries, and so forth); based on a request from personnel; or based on a determined identity of an individual (e.g., project manager, accountant, field operator, engineer, etc.) or any other suitable data. Examples of campaign items include content data associated with human resources (HR), information technology (IT), accounting, insurance, and the like, such as data or actions associated with health insurance, retirement plans, savings accounts, employee training, password management, and so forth.

As used herein, “campaign-related activities” refer to specific campaign-related content requiring action from a targeted (e.g., assigned) individual (i.e., a campaign participant). For example, an enterprise may assign and send new hired employees a campaign-related activity associated with accepting the terms and conditions of an assigned insurance policy. Since this campaign-related content requires an action (e.g., accepting the terms and conditions) by a participant, it may be referred to as a “campaign-related activity.” The campaign items and/or campaign-related activities in the campaign may be sequentially associated to one another or organized in any suitable manner, such that completion of a campaign-related activity enables the participant to receive or have access to a subsequent campaign item or a subsequent campaign-related activity. Additionally or alternatively, the campaign items and/or campaign-related activities may be organized or connected in non-linear networks (e.g., webs) having many nodes that may define a plurality of paths, such that different paths along the campaign may be taken as the assigned participant completes campaign-related activities based on the identity of the participant, selected responses or actions to a given campaign-related activity (e.g., selection of an insurance plan from among several options), and so forth. For example, a first participant (e.g., a new hired employee) may be associated with a first campaign (or a first path along a campaign having web-like arrangement) having a first set of campaign items and campaign-related activities, while a second participant (e.g., a project manager having ten years of experience) may be associated with a second campaign (or a second path along a campaign having web-like arrangement) having a second set of campaign items and campaign-related activities. The first and second set of campaign items and campaign-related activities may be different from one another, include a subset of similar campaign items and campaign-related activities, or be identical.

In certain contexts, some participants may complete their assigned campaign-related activities, while other participants may not complete their assigned campaign-related activities, such that progress within a campaign may differ between the participants. Further, as noted above, even within the same campaign, the content disseminated to different campaign participants may differ based on numerous factors. As may be appreciated, managing campaigns to enable personalization and customization and taking into account participant's different progress through the campaign may be difficult to implement in practice.

With this in mind, the present approach includes improving the management of campaign-related content, for example, within enterprises and organizations by providing systems and methods for determining completion of campaign-related activity and assigning subsequent actions in response to completion of the campaign-related activity. In one embodiment, a computing system accessible to an administrator or manager of the campaign may recognize as complete a campaign-related activity in response to individual completion of the action associated with the campaign-related activity and may recognize as incomplete an outstanding campaign-related activity in response to determining that the participant has not engaged with or completed the action associated with the outstanding campaign-related activity. Furthermore, the present approach includes assigning personalized subsequent campaign-related activities and campaign items to the users based at least on whether the campaign-related activity was completed or not. The present approach may improve the efficiency by which campaigns are managed by facilitating tracking completion of campaign-related activities and participant progress throughout a campaign.

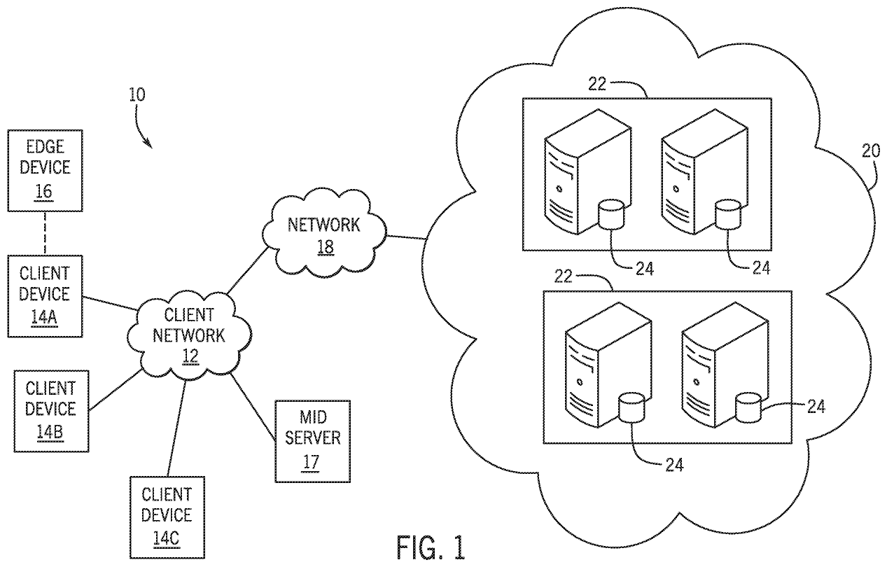

For example, an individual who has not completed a campaign-related activity may be sent a reminder notification (e.g., reminder email, a dashboard reminder upon login, and so forth), while another individual who has completed the campaign-related activity may receive a subsequent campaign-related message or activity for completion. An administrator may access information useful in determining completion of campaign-related activities, such as a list of participants who have completed the campaign-related activity and a second list of participants who have not competed the campaign-related activity. In this manner, enterprises implementing the embodiments disclosed herein may better manage the personalized assignment of campaign items and track the completion of campaign-related activities and progress of campaigns for each of their diverse individuals. Additional details with regard to the embodiments described herein will be discussed below with reference to FIGS. 1-15.

With the preceding in mind, and by way of context, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a computing system 10, such as a cloud computing system, where embodiments of the present disclosure may operate, is illustrated. Computing system 10 may include a client network 12, a network 18 (e.g., the Internet), and a cloud-based platform 20. In some implementations, the cloud-based platform may be a configuration management database (CMDB) platform. In one embodiment, the client network 12 may be a local private network, such as local area network (LAN) having a variety of network devices that include, but are not limited to, switches, servers, and routers. In another embodiment, the client network 12 represents an enterprise network that may include one or more LANs, virtual networks, data centers 22, and/or other remote networks. As shown in FIG. 1, the client network 12 is able to connect to one or more client devices 14A, 14B, and 14C so that the client devices are able to communicate with each other and/or with the network hosting the platform 20. The client devices 14A-C may be computing systems and/or other types of computing devices generally referred to as Internet of Things (IoT) devices that access cloud computing services, for example, via a web browser application or via an edge device 16 that may act as a gateway between the client devices 14A-C and the platform 20. FIG. 1 also illustrates that the client network 12 includes a bridge device or server, such as a management, instrumentation, and discovery (MID) server 17 that facilitates communication of data between the network hosting the platform 20, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 18. The network 18 may include one or more computing networks, such as other LANs, wide area networks (WAN), the Internet, and/or other remote networks, to transfer data between the client devices 14A-C and the network hosting the platform 20. Each of the computing networks within network 18 may contain wired and/or wireless programmable devices that operate in the electrical and/or optical domain. For example, network 18 may include wireless networks, such as cellular networks (e.g., Global System for Mobile Communications (GSM) based cellular network), IEEE 802.11 networks, and/or other suitable radio-based networks. The network 18 may also employ any number of network communication protocols, such as Transmission Control Protocol (TCP) and Internet Protocol (IP). Although not explicitly shown in FIG. 1, network 18 may include a variety of network devices, such as servers, routers, network switches, and/or other network hardware devices configured to transport data over the network 18.

In FIG. 1, the network hosting the platform 20 may be a remote network (e.g., a cloud network) that is able to communicate with the client devices 14A-C via the client network 12 and network 18. The network hosting the platform 20 provides additional computing resources to the client devices 14A-C and/or client network 12. For example, by utilizing the network hosting the platform 20, users of client devices 14A-C are able to build and execute applications for various enterprise, IT, and/or other organization-related functions. In one embodiment, the network hosting the platform 20 is implemented on one or more data centers 22, where each data center could correspond to a different geographic location. Each of the data centers 22 includes a plurality of virtual servers 24 (which may be referenced herein as application nodes, application servers, virtual server instances, application instances, or application server instances), where each virtual server can be implemented on a physical computing system, such as a single electronic computing device (e.g., a single physical hardware server) or across multiple-computing devices (e.g., multiple physical hardware servers). Examples of virtual servers 24 include, but are not limited to a web server (e.g., a unitary web server installation), an application server (e.g., unitary JAVA Virtual Machine), and/or a database server (e.g., a unitary relational database management system (RDBMS) catalog).

To utilize computing resources within the platform 20, network operators may choose to configure the data centers 22 using a variety of computing infrastructures. In one embodiment, one or more of the data centers 22 are configured using a multi-tenant cloud architecture, such that one of the server instances handles requests from and serves multiple customers. Data centers with multi-tenant cloud architecture commingle and store data from multiple customers, where multiple customer instances are assigned to one of the virtual servers 24. In a multi-tenant cloud architecture, the particular virtual server 24 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from certain drawbacks, such as a failure of a particular one of the server instances causing outages for all customers allocated to the particular server instance.

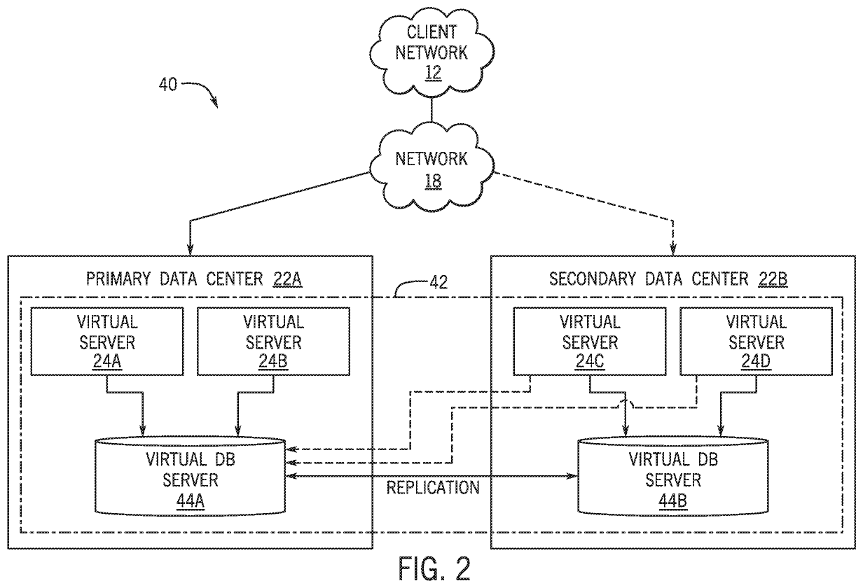

In another embodiment, one or more of the data centers 22 are configured using a multi-instance cloud architecture to provide every customer its own unique customer instance or instances. For example, a multi-instance cloud architecture could provide each customer instance with its own dedicated application server(s) and dedicated database server(s). In other examples, the multi-instance cloud architecture could deploy a single physical or virtual server and/or other combinations of physical and/or virtual servers 24, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 20, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 40 where embodiments of the present disclosure may operate. FIG. 2 illustrates that the multi-instance cloud architecture 40 includes the client network 12 and the network 18 that connect to two (e.g., paired) data centers 22A and 22B that may be geographically separated from one another. Using FIG. 2 as an example, network environment and service provider cloud infrastructure client instance 42 (also referred to herein as a client instance 42) is associated with (e.g., supported and enabled by) dedicated virtual servers (e.g., virtual servers 24A, 24B, 24C, and 24D) and dedicated database servers (e.g., virtual database servers 44A and 44B). Stated another way, the virtual servers 24A-24D and virtual database servers 44A and 44B are not shared with other client instances and are specific to the respective client instance 42. Other embodiments of the multi-instance cloud architecture 40 could include other types of dedicated virtual servers, such as a web server. For example, the client instance 42 could be associated with (e.g., supported and enabled by) the dedicated virtual servers 24A-24D, dedicated virtual database servers 44A and 44B, and additional dedicated virtual web servers (not shown in FIG. 2).

In the depicted example, to facilitate availability of the client instance 42, the virtual servers 24A-24D and virtual database servers 44A and 44B are allocated to two different data centers 22A and 22B, where one of the data centers 22 acts as a backup data center. In reference to FIG. 2, data center 22A acts as a primary data center that includes a primary pair of virtual servers 24A and 24B and the primary virtual database server 44A associated with the client instance 42. Data center 22B acts as a secondary data center 22B to back up the primary data center 22A for the client instance 42. To back up the primary data center 22A for the client instance 42, the secondary data center 22B includes a secondary pair of virtual servers 24C and 24D and a secondary virtual database server 44B. The primary virtual database server 44A is able to replicate data to the secondary virtual database server 44B (e.g., via the network 18).

As shown in FIG. 2, the primary virtual database server 44A may back up data to the secondary virtual database server 44B using a database replication operation. The replication of data between data may be implemented by performing full backups weekly and daily incremental backups in both data centers 22A and 22B. Having both a primary data center 22A and secondary data center 22B allows data traffic that typically travels to the primary data center 22A for the client instance 42 to be diverted to the second data center 22B during a failure and/or maintenance scenario. Using FIG. 2 as an example, if the virtual servers 24A and 24B and/or primary virtual database server 44A fails and/or is under maintenance, data traffic for client instances 42 can be diverted to the secondary virtual servers 24C and/or 24D and the secondary virtual database server instance 44B for processing.

Although FIGS. 1 and 2 illustrate specific embodiments of a cloud computing system 10 and a multi-instance cloud architecture 40, respectively, the disclosure is not limited to the specific embodiments illustrated in FIGS. 1 and 2. For instance, although FIG. 1 illustrates that the platform 20 is implemented using data centers, other embodiments of the platform 20 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For example, using FIG. 2 as an example, the virtual servers 24A-D and virtual database servers 44A and 44B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, although virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

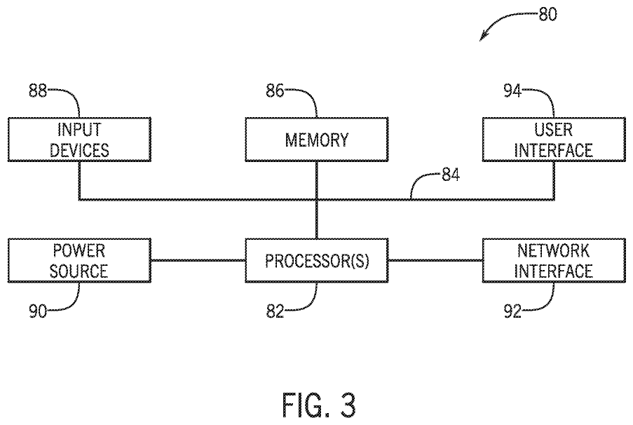

With this in mind, and by way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as those shown in FIG. 3, may be used in supporting or communicating with one or more virtual environments or computational instances on which the present approach may be implemented.

With this in mind, an example computer system may include some or all of the computer components depicted in FIG. 3 and may be present in the embodiments of FIGS. 1 and 2. FIG. 3 generally illustrates a block diagram of example components of a computing system 80 and their potential interconnections or communication paths, such as along one or more busses 84. As illustrated, the computing system 80 may include various hardware components such as, but not limited to, one or more processors 82, one or more busses 84, memory 86, input devices 88, a power source 90, a network interface 92, a user interface 94, and/or other computer components useful in performing the functions described herein. The one or more processors 82 may include one or more microprocessors capable of performing instructions stored in the memory 86. Additionally or alternatively, the one or more processors 82 may include application-specific integrated circuits (ASICs), field-programmable gate arrays (FPGAs), and/or other devices designed to perform some or all of the functions discussed herein without calling instructions from the memory 86.

With respect to other components, the one or more busses 84 includes suitable electrical channels to provide data and/or power between the various components of the computing system 80. The memory 86 may include any tangible, non-transitory, and computer-readable storage media. Although shown as a single block in FIG. 1, the memory 86 can be implemented using multiple physical units of the same or different types in one or more physical locations. The input devices 88 correspond to structures employed to input data and/or commands to the one or more processor 82. For example, the input devices 88 may include a mouse, touchpad, touchscreen, keyboard, and the like. The power source 90 can be any suitable source for power of the various components of the computing system 80, such as a line power and/or a battery source. The network interface 92 includes one or more transceivers capable of communicating with other devices over one or more networks (e.g., a communication channel). The network interface 92 may provide a wired network interface or a wireless network interface. A user interface 94 may include a display that is configured to display text or images transferred to it from the one or more processors 82. In addition and/or alternative to the display, the user interface 94 may include other devices for interfacing with a user, such as lights (e.g., LEDs), speakers, and the like.

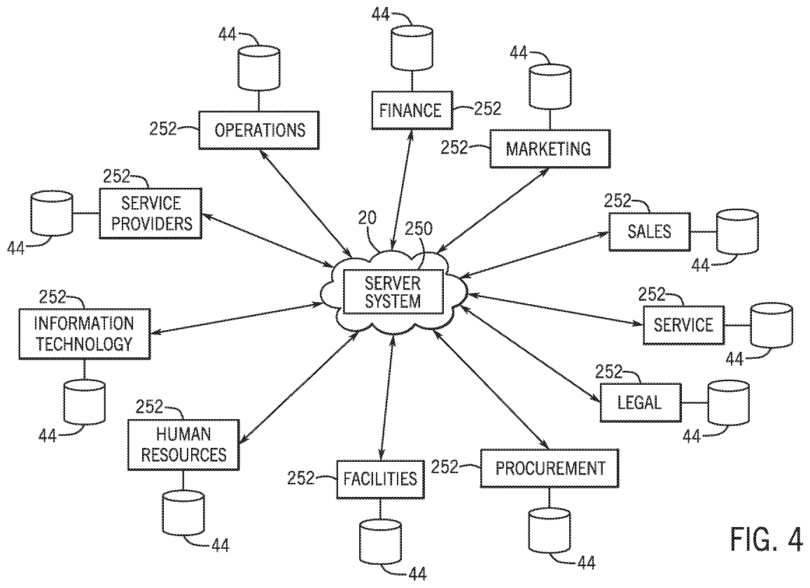

With the preceding in mind, FIG. 4 illustrates a block diagram of an embodiment of a server system that may be communicatively coupled to different department server systems via the platform 20. As mentioned above, an enterprise or organization may be made up of a number of different departments, each running their own applications as well as applications shared throughout the enterprise. In one embodiment, a server system 250 include a computing system 80 or the like having access to the platform 20. The server system 250 may access different databases 44 associated with different departments to access documents, templates, and/or information about the department useful in defining or determining the campaign-related content, as discussed herein. In this manner, the server system 250 may access the databases 44 to retrieve campaign-related activities, such as actions and/or tasks requiring completion by a participant assigned the actions and/or tasks that may be relevant to a given department. In the depicted example, each database 44 associated with a respective department may communicate with the server system 250 via the platform 20, and a computing system 10 may communicate with the server system 250 to relay information to appropriate personnel, such as an administrator. For example, FIG. 4 illustrates a number of server systems 252 which may include campaign-related content relevant to a subset of individuals of an enterprise.

By way of example, the department server systems 252 may be associated with departments such as an operations department, a finance department, a marketing department, a sales department, a service department, a legal department, a procurement department, a facilities department, a human resources department, an information technology department, a service department, and the like. It should be noted that the preceding list of departments should not be construed as an exclusive list of departments. Instead, the listed departments are provided as examples that may be generally found in an organization and a given enterprise may include additional or alternative departments, including other departments or divisions having campaign-related content relevant to the individuals of the enterprise.

Generally, one or more databases 44 may include identification data related to the individuals of the enterprise and/or may include campaign-related activities associated with one or more of the department or with the organization as a whole. Identification data may include a name of the individual, a role of the individual within the enterprise (or department), personal information (e.g., the age, education level, residence address, ethnicity, etc.), working schedule of the individual, a list of skills of the individual, a list of job functions performed by the individual, and/or any other information useful in distinguishing the individual from other individuals to improve the assigning of and tracking of the completion of campaign-related content. In one embodiment, the campaigns, the assignment of campaign-related activities, and the transmission of campaign items to assigned individuals may be based at least in part on identification data that may be used to characterize or categorize groups of individuals (e.g., employees). Furthermore, determining whether to assign an individual the campaign-related content may be based, at least in part, on the identity data. The campaign-related content may include calendar information related to the deadline for completion of the campaign-related activities associated with the respective department, metadata including an action criteria for an action that, if taken by the assigned individual, would result in completion of the campaign-related activity, and the like.

Given the number of different departments associated with a single enterprise, as illustrated in FIG. 4, and given the large number of individuals within each department, it may be difficult to track participant completion of campaign-related activities and to, upon completion of certain activities, assign subsequent campaign-related content to the participant. For example, new employees, who may start at different times throughout the year, may need to select a desired insurance plan for enrollment before being prompted to sign the appropriate selection paperwork. Additionally, certain documents may be drafted to cover all employees of an enterprise. However, only a portion of the document may be applicable to a given employee. It may, therefore, be beneficial to coordinate the generation of personalized campaign items and/or personalized campaign-related activities such that the campaign items and campaign-related activities are targeted (e.g., directed) to specific individuals, for example, based on their identification data.

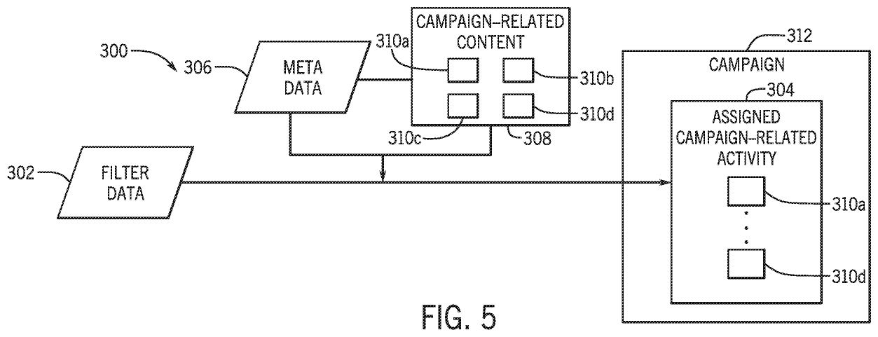

By way of example, FIG. 5 illustrates a flow diagram 300 that illustrates a method of how campaign-related activities may be assigned, such as in response to completion of an earlier campaign-related activity. The steps illustrated in the flow diagram 300 may be performed by one or more computing systems 10 on the network 18 for the purpose of managing campaign-related content across the various departments of an enterprise. Furthermore, the steps illustrated in the flow diagram 300 are meant to facilitate discussion and are not intended to limit the scope of this disclosure, since additional steps may be performed, certain steps may be omitted, and the illustrated steps may be performed in an alternative order.

In one embodiment, filter data 302 is used to facilitate assigning campaign-related activities 304 based on metadata 306 (e.g., demographic and/or employment information about an employee, an indication that a participant competed a certain campaign-related activity, and so forth) associated with campaign-related content 308 (e.g., data associated with the campaign items, the campaign-related activity, the campaign, and so forth) and/or subsets 310a, 310b, 310c, and 310d of the campaign-related content 308. The assigned campaign-related activities 304 may include one or more subsets 310 of the campaign-related content 308 determined to be relevant to a specific participant, in this example, subsets 310a, and 310d. In some embodiments, selection of the relevant subsets 310 may be based on the identification data of the targeted individual or prior selections made or actions performed by the individual, as discussed above. Such selection data may be specified by the represented filter data 302. The assigned campaign-related activities 304 may be part of a campaign 312. It should be understood that the subsets 310 of the campaign-related content 308 assigned as participant-specific campaign-related information or activity 304 are not limited to subsets of campaign-related content from a single campaign-related content 308 store or document, but may be drawn from a variety of sources of campaign-related content determined to be relevant to a particular individual. In some embodiments, the subsets 310 of campaign-related content 308 used to generate the assigned campaign-related activity 304 may come from one or more databases 44 (FIG. 4) or be assigned by authorized personnel (e.g., administrators or campaign managers).

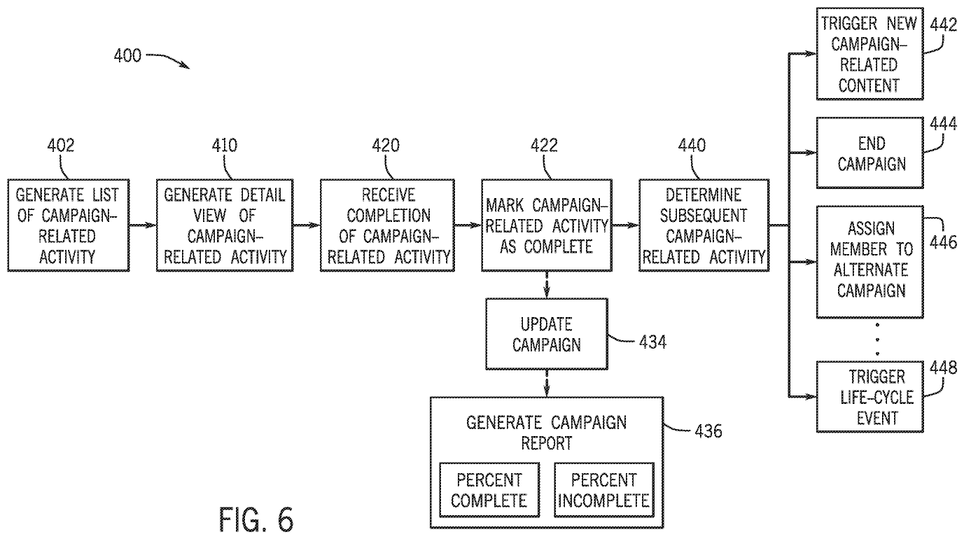

FIG. 6 is a flow diagram 400 of steps performed in managing campaigns 312 (FIG. 5) that include determining completion of a campaign-related activity 304 (FIG. 5) and assigning subsequent actions, in accordance with aspects of the present disclosure. In one implementation, a computing platform used to implement or monitor a campaign may generate (process block 402) a list of the assigned campaign-related activities. The computing system 10 may generate (process block 402) a list of the campaign-related activities 304 on a client instance 42 (FIG. 1) associated with the intended participant. In one embodiment, the list of the campaign-related activities 304 may be viewable via a GUI.

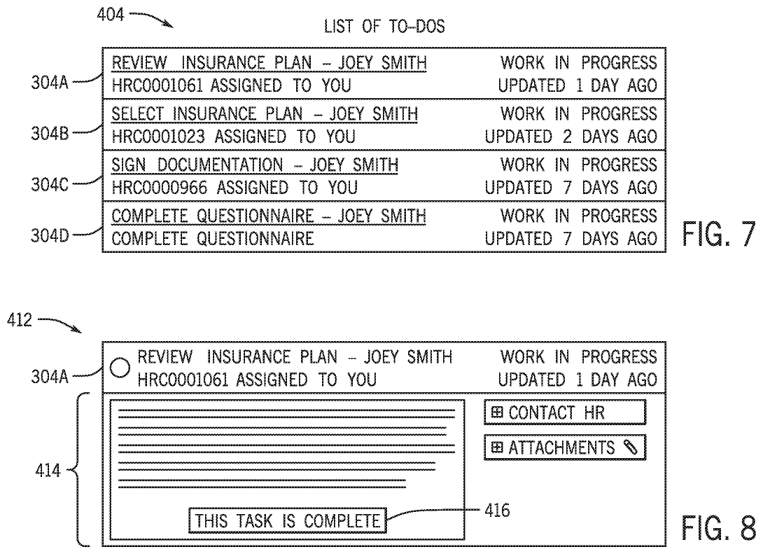

To help illustrate, FIG. 7 depicts a list 404 of campaign-related activities 304 that may be assigned to a participant, in accordance with aspects of the present disclosure. Some or all of the list 404 of campaign-related activities 304 may be accessed by the assigned participant for completion and/or may be accessed by an administrator for viewing purposes, for example, to determine whether the intended participants have completed the assigned campaign-related activities 304. In the illustrated embodiment, the list 404 includes three campaign-related activities 304 associated with an intended participant, in this example, “Joey Smith.” An initial campaign-related activity 304A of a campaign 312 may require the assigned participant (e.g., Joey Smith) to review available insurance plans. A subsequent campaign-related activity 304B of the campaign 312 may require the assigned participant (e.g., Joey Smith) to select an insurance plan from the available insurance plans the assigned participant reviewed. Another subsequent campaign-related activity 304C may require the assigned participant (e.g., Joey Smith) to sign documentation related to the selection and provide covered dependent information. Yet another subsequent campaign-related activity 304D may require the assigned participant (e.g., Joey Smith) to complete a checklist as to whether the offered policies meet the individual's coverage needs. While in some embodiments, campaign-related content may be viewed as a list 404 by a participant, in other embodiments, the computing system 10 may assign each campaign-related content 308 sequentially, for example, after a preceding campaign-related activity is completed by the participant. Furthermore, in some implementations, the list 404 may be available to authorized personnel (e.g., campaign managers) so they may be able to quickly view participant progress within a campaign 312.

The list 404 may be received by the assigned participants via any suitable communication technique, such as email or displayed on a portal login screen for review upon logging into a client instance to work . . . . Furthermore, each campaign-related activity 304 in the list 404 may include an assignment number (in this example “HRC0001061,” “HRC0001023,” or “HRC0000966,” useful when looking up the assigned campaign-related activity), the assigned participant (in this example, Joey Smith), a status (in this example, “Work in progress”), and a timeframe for when the campaign-related activity 304 was last updated (e.g., two days ago). In some contexts, the status may change from “Work in Progress” to “Completed” in response to the assigned participant performing the required action, in this example, reading the terms, selecting a management plan, or approving the expense report. It should be understood that in another embodiment, the assignment number, the timeframe, and/or the status may be omitted.

Turning back to FIG. 6, in addition or alternatively to generating (process block 402) the list 404 of campaign-related activities 304 relevant to an individual, the computing system 10 may generate a detail view of the campaign-related activities 304. In some contexts, the list 404 may be present as a summary or thumbnail view of actions needing to be performed by a campaign participant. A detail view of the relevant campaign tasks may be displayed at certain points in the campaign or when more information on the campaign is requested by a participant.

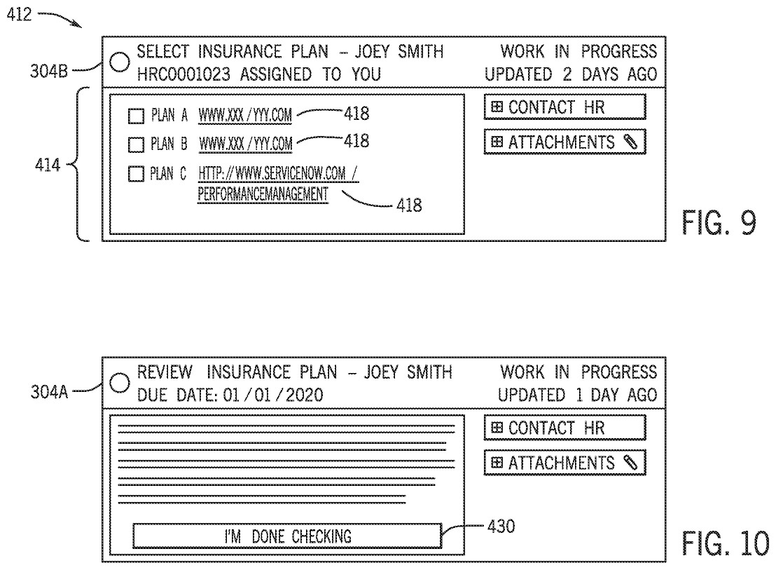

To help illustrate detail views of the campaign-related activities 304, FIGS. 8 and 9 is an example of a detail view 412 of respective campaign-related activities 304 of a campaign 312. The detail view 412 may include additional information 414 (e.g., text, images, links, selectable features, etc.) associated with the campaign-related activities 304. In some embodiments, the additional information 414 may include instructions for the requirements for completing the campaign-related activity 304. The detail view 412 may include a button 416, link 418, or other engagable feature, that when acted on (e.g., selected), may result in completion of the campaign-related activity 304. In some contexts, the additional features 414 may include an option for contacting certain personnel (e.g., contact HR) or another option for uploading attachment.

Specifically, FIG. 8 depicts a detail view 412 of an initial campaign-related activity 304A, in accordance with aspects of the present disclosure. As mentioned above, the initial campaign-related activity 304A may require the intended participant (e.g., Joey Smith) to read the terms regarding their open enrollment insurance policy. Compared to the initial campaign-related activity 304A as presented in the list 404, the initial campaign-related activity 304A in the detail view 412 includes additional information or options 414 not present in the list or summary view. For example, the detail view 412 may include a button 416, that when selected (e.g., may confirm review of the insurance plans), results in completion of the initial campaign-related activity 304A.

FIG. 9 depicts a detail view 412 of a subsequent campaign-related activity 304B (e.g., subsequent from the initial campaign-related activity 304A), in accordance with aspects of the present disclosure. As mentioned above, the subsequent campaign-related activity 304B may require the assigned participant (e.g., Joey Smith) to select an insurance plan from the available plans the assigned participant reviewed. Compared to the subsequent campaign-related activity 304B as presented in the list 404, the subsequent campaign-related activity 304B in the detail view includes additional features 414 not present in the list. For example, the detail view 412 may include a link 418 for selecting the desired insurance plan, that when selected, may result in selection of an insurance plan and result in completion of the subsequent campaign-related activity 304B of the campaign 312.

Turning back to FIG. 6, the platform on which the campaign 312 is implemented may receive (process block 420) an indication that a campaign-related activity 304 is complete and mark (process block 422) that campaign-related activity 304 as complete. That is, in response to a participant performing the campaign-related activity or action associated with the campaign-related activity 304, an indication is received (process block 420) of this completion and the campaign-related activity is indicated as complete. (process block 422). In this manner, the platform may track progress of a campaign for any number of participants.

FIGS. 10-13 each depict campaign-related activities 304 requiring a specific action resulting for completion. FIG. 10 depicts an example of the initial campaign-related activity 304A of FIG. 8 requiring the assigned participant to review the available insurance plans, in accordance with aspects of the present disclosure. For example, selection of an acceptance button 430 may result in the initial campaign-related activity 304A being marked (process block 422) as complete for the participant performing the selection. In one embodiment, the computing system 10 may mark the campaign-related activity 304 as complete within the campaign 312.

FIG. 11 depicts an example of the subsequent campaign-related activity 304B of FIG. 9 requiring the assigned participant to select an insurance plan from the available insurance plans that were viewed by the participant (e.g., in the initial campaign-related activity), in accordance with aspects of the present disclosure. As such, clicking on the link 418 corresponding to the insurance plan the participant wishes to select may result in the subsequent campaign-related activity 304B for the assigned participant being marked (process block 422) as complete. In this manner, the assigned participant may be held accountable for selecting the insurance plan and being familiar with the content in the selected link 418, and administrators may have access to information regarding whether the assigned participant made a selection of a link 418 and viewed the link as evident by whether the assigned participant executed/completed the subsequent campaign-related activity 304B.

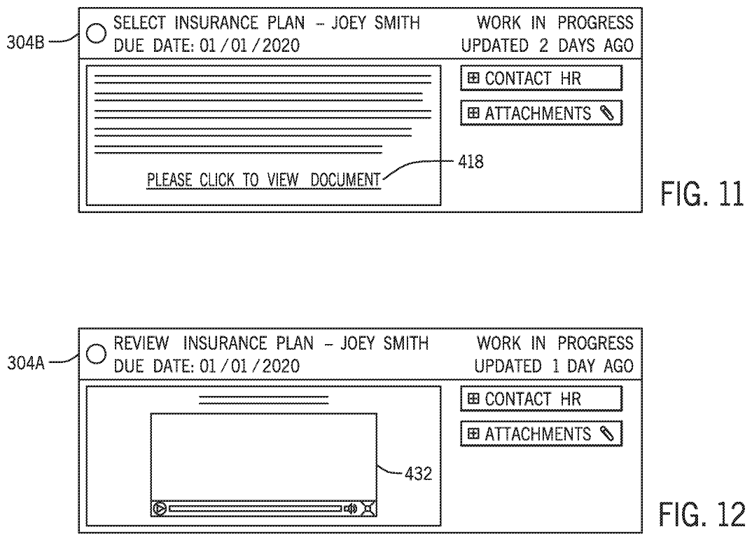

FIG. 12 depicts an example of the initial campaign-related activity 304A of FIG. 8 requiring another action, viewing a video, for completion, in accordance with aspects of the present disclosure. As mentioned above, the initial campaign-related activity 304 may require the assigned participant (e.g., Joey Smith) to review available insurance plans. In this example, the available insurance plans may be presented to the participant as a video, such that it may be necessary for the assigned participant to view the video 432. In this manner, the assigned participant may be held responsible for being familiar with the content in the video 432. In one embodiment, the initial campaign-related activity 304A, in this example, the campaign-related activity of viewing the video 432, may be marked (process block 422) as complete after the assigned participant clicks play on the video 432 and/or views the entire video 432. In this manner, the assigned participant (e.g., an executive) may be held responsible for being familiar with the content (e.g., regarding the available insurance plans presented) in the video 432, and administrators may have access to information regarding whether the assigned participant viewed the video 432 as evident by whether the assigned participant executed/completed the initial campaign-related activity 304A.

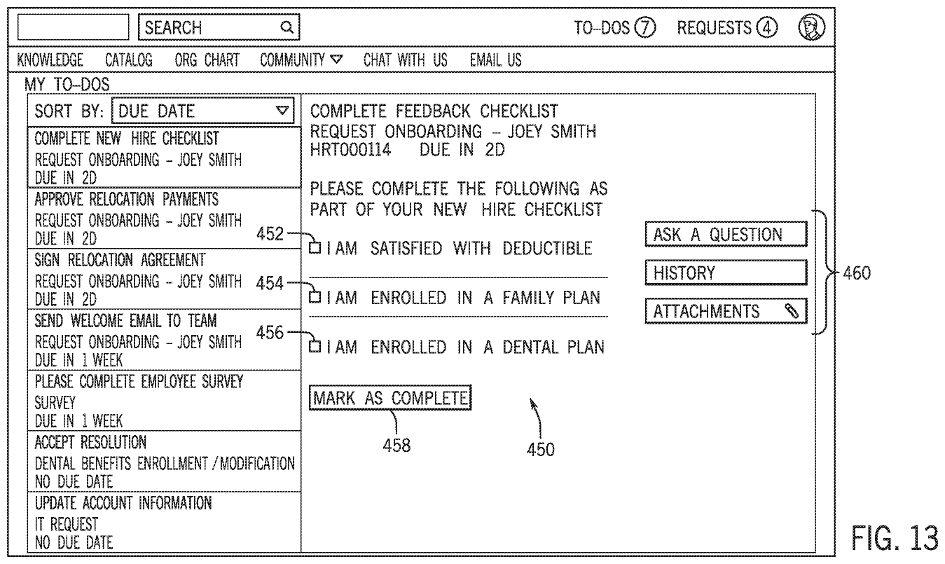

FIG. 13 depicts an example of another subsequent campaign-related activity 304D requiring another action, completing a checklist 450, for completion, in accordance with aspects of the present disclosure. For example, it may be necessary for the assigned participant to complete a checklist 450, such as the illustrated checklist (e.g., feedback checklist), so the assigned participant responsible for making selections regarding whether the offered policies meet the individual's coverage needs. In this example, the assigned participant may check (e.g., select) a first box 452 to indicate that she/he is satisfied with the deductible, check (e.g., select) a second box 454 to indicate that she/he will be enrolled in a family plan, check (e.g., select) a third box 456 to indicate that she/he will be enrolled in a dental plan (as part of the selected insurance plan), and so forth. In this manner, the administrator may view which assigned participants have completed the other subsequent campaign-related activity 304D, for example, to determine who to call to discuss ways of improving insurance coverage for an individual determined to be unsatisfied with their selected insurance plan, based on the selection and completion of the other campaign-related activity 304D.

The use and discussion of FIGS. 10-13 are only examples to facilitate ease of description and explanation and are not intended to limit the disclosure to the specific examples illustrated therein. That is, while FIGS. 10-13 illustrate campaign-related activities that may include requiring action from an assigned participant, such that the action may include selecting (e.g., clicking on) an acceptance button 430, selecting to view a link 418 (e.g., clicking on the link), viewing a video 432, and/or completing a checklist 450, it should be understood that the action may include any other campaign-related activity assigned to a participant. For example, in some contexts, the action may include accepting an HR service, submitting a catalog item, submitting an order guide, executing a checklist, taking a survey, uploading specific documents, and/or executing a signature, such as an electronic signature (i.e., E-signature).

Turning back to FIG. 6, in response to receiving (process block 420) an indication of completion of a campaign-related activity 304 and marking (process block 422) the campaign-related activity 304 as complete, the computing system 10 may update (process block 434) progress of the campaign 312 for the associated individual to reflect completion of the campaign-related activity 304. As discussed above, the individuals of the enterprise may each be associated with a campaign 312. Updating (process block 434) the progress of the campaign 312 for the corresponding individual may include designating the as complete the executed campaign-related activities 304 of the campaign 312. For example, the computing system 10 may update (process block 434) the campaign to determine a percent progress (i.e., a percent of the total campaign-related activities and campaign items associated with the individual that have been completed).

In one embodiment, the computing system 10 may present this progress in a campaign report. That is, the computing system 10 may generate (process block 434) a campaign report of the campaign 312 for a corresponding individual to a requester, such as an enterprise administrator seeking to retrieve progress of a campaign 312 associated with an individual. In another embodiment, the computing system 10 may generate (process block 436) the campaign report to the individual to whom the campaign report includes campaign data 308 about. That is, the computing system 10 may generate (process block 436) and output the campaign report in response to a request (e.g., from an individual or enterprise administrator). The campaign report may be useful in determining a corresponding individual's progress in completing the various campaign items and campaign-related activities on the campaign for the corresponding individual. For example, in one embodiment, the campaign report may include a list of completed campaign items and/or campaign-related activities and a second list of uncompleted campaign items and/or campaign-related activities. The completed and uncompleted campaign items and/or campaign-related activities may be expressed as percentages of the total campaign items and/or campaign-related activities.

In some embodiments, after an executed campaign-related activity is marked (process block 422) as complete, the computing system 10 may determine (process block 440) a subsequent action to assign the individual. The subsequent action may include triggering (process block 442) new campaign-related content 308, ending (process block 444) the campaign 312, assigning (process block 446) the individual to an alternative campaign 312, triggering (process block 448) life-cycle events.

In one example, triggering (process block 442) the new content may include updating the list 404 or detail view 412 of campaign-related activities to include the new campaign-related content 308. The new campaign-related content 308 be assigned to the individual automatically based on the campaign 312 or may be assigned manually based on administrator request. For example, in response to the individual executing the action (e.g., watching the video 432 associated to the open enrollment) to complete the initial campaign-related activity 304A (e.g., watching the video 432), the computing system 10 automatically may trigger (process block 442) new campaign-related content, such as a campaign-related activity requesting the individual select a payment plan to associate to the open enrollment. In additional embodiment, the triggered new content may be a campaign item, such as an email thanking the individual for completing the campaign-related activity, and/or may be manually assigned by an administrator.

In another example, in response to the individual completing a specific campaign-related activity and the computer system 10 marking (process block 422) the campaign-related activity as completed, the computing system 10 may end (process block 444) the campaign 312 associated with the completed campaign-related activity 304. In one embodiment, the computing system 10 may end (process block 444) the campaign 312 when the completed campaign-related activity 304 is the last campaign-related activity 304 of the campaign 312 associated with the individual.

In another example, in response to the individual completing a specific campaign-related activity and the computer system marking (process block 422) the campaign-related activity as completed, the computing system 10 may assign (process block 446) the individual to another campaign 312. That is, in response to receiving an indication of completion of the campaign-related activity 304, the computing system 10 may assign the individual to another campaign item or campaign-related activity associated with another campaign. In this manner, the computing system 10 may change association of the individual to associate the individual to another campaign 312.

In yet another example, in response to the individual completing a specific campaign-related activity and the computer system marking (process block 422) the campaign-related activity as completed, the computing system 10 may trigger (process block 448) a life-cycle event. As used herein, a “life-cycle event” may refer to any life event.

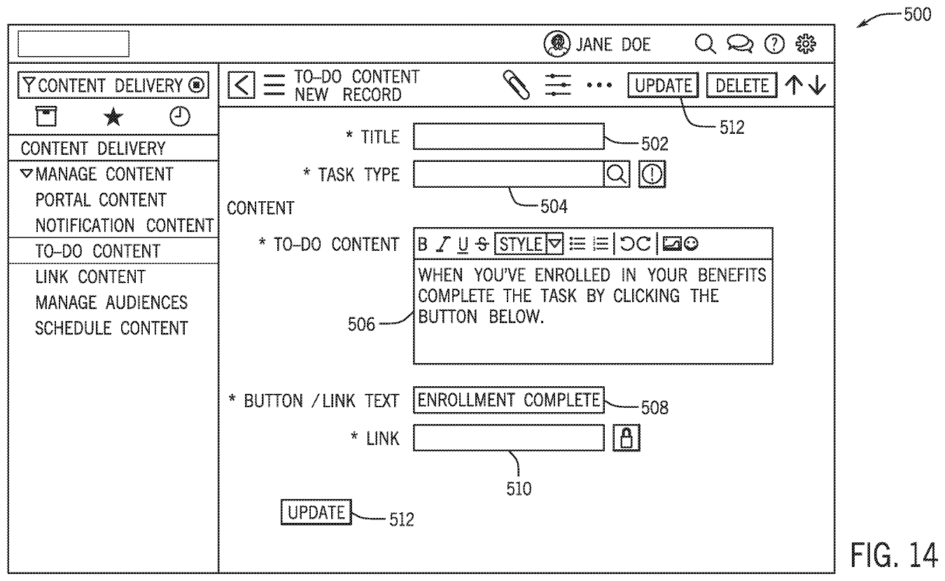

FIG. 14 depicts an example of a create window 500 for creating a campaign-related activity, in accordance with aspects of the present disclosure. In one embodiment, authorized personnel, such as administrators or campaign managers, may utilize the create window 500 to create campaign-related content sent out to targeted individuals. The window 500 includes prompts for specifying aspects of the created campaign-related activity. As illustrated, the create window 500 may include a first prompt 502 for specifying a title of the created campaign-related activity 304, a second prompt 504 for specifying the task type (e.g., a selectable/clickable button, a selectable link, a viewable video, a survey, and the like), a third prompt 506 for specifying instructions indicating what actions are required of an individual for completion of the created campaign-related activity, a fourth prompt 508 for specifying whether the created campaign-related activity will be a button 416 or a link 418, and/or a fifth prompt 510 for specifying a Uniform Resource Locator (URL) of the link when the created campaign-related activity 304 is intended to be a selectable link.

In one embodiment, specifying the second prompt 504 may include clicking on a search button and navigating a list of task types, such as “Click-Link,” “Complete Button,” and the like. The administrator creating the campaign-related activity 304 may then select from the list of task type to specify the task type. In one embodiment, the fourth prompt 508 may receive text characters, in this example “Enrollment Complete,” for specifying what the button 416 will be labeled as when created. The fifth prompt 510 may receive the URL that the individual must click on when the link 418 is created. It should be understood that in some embodiments, any of the prompts may be left blank. After the administrator has specified the fields specifying the aspects of the created campaign-related activity 304, the administrator may select the update button 512 to create the campaign-related activity 304.

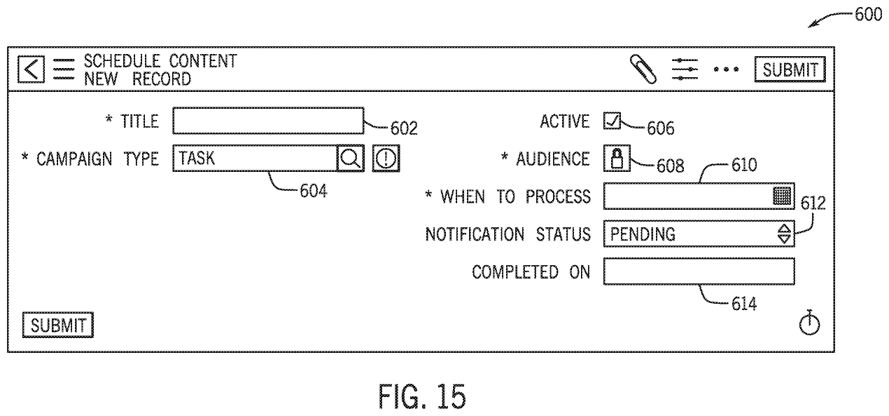

FIG. 15 depicts an example of a scheduling window 600 for specifying a schedule associated with the created campaign-related activity 304 of FIG. 14, in accordance with aspects of the present disclosure. After the campaign-related activity 304 is created, the computing system 10 may present the scheduling window 600, enabling an administrator to specify a title 602, campaign type 604 (e.g., whether the created item of the campaign is a campaign-related activity or a campaign), an active status 606, an intended audience 608 (i.e., assigned individuals), a process date 610, a notification status 612, and a target completion date 614 (e.g., which may be specified when the assigned individual is sent the created task 304).

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system, comprising:
one or more client instances hosted by a platform, wherein the one or more client instances are accessible by one or more remote client networks, and wherein the system is configured to perform operations comprising:
retrieving data regarding a campaign from one or more databases accessible by the one or more client instances, wherein the campaign comprises one or more campaign-related activities to be performed by each individual of a group;
marking as incomplete the one or more campaign-related activities not performed by respective individuals of the group and marking as complete the one or more campaign-related activities performed by the respective individuals of the group;
determining first subsequent campaign-related content for a first set of individuals in response to determining that the first set of individuals have engaged with the one or more campaign-related activities;
determining second subsequent campaign-related content for a second set of individuals in response to determining that the second set of individuals have not engaged with the one or more campaign-related activities; and
presenting the first subsequent campaign-related content to the first set of individuals and the second subsequent campaign-related content to the second set of individuals based on the determinations.

2. The system of claim 1, wherein the operations comprises assigning another subsequent campaign-related content to the second set of individuals in response to determining that the second set of individuals engaged with the second subsequent campaign-related content.

3. The system of claim 1, wherein the campaign-related content comprises one or more additional campaign-related activities, one or more campaign items, or both, associated with each individual of the group based on a determination that identification data of each individual of the group satisfies a criteria.

4. The system of claim 1, wherein engaging with the one or more campaign-related activities comprises selecting a button, watching a video, clicking on a link, submitting a catalog item, submitting an order guide, executing a checklist, signing documentation, taking a survey, uploading documents, or any combination thereof.

5. The system of claim 1, wherein outputting the first subsequent campaign-related content to the first set of individuals comprises sending the first set of individuals a reminder to engage with the one or more campaign-related activities.

6. The system of claim 1, wherein outputting the second subsequent campaign-related content to the second set of individuals comprises assigning a new campaign-related activity, ending the campaign, assigning the second set of individuals to another campaign, triggering a life-cycle event, or any combination thereof.

7. The system of claim 1, wherein each individual of the group is assigned to a corresponding campaign.

8. The system of claim 7, wherein completion progress of the one or more campaign-related activities in the corresponding campaign is independent of one another.

9. The system of claim 1, wherein the campaign comprises a plurality of campaign-related activities, campaign items, or both, associated in a neural network configuration.

10. A processor-implemented method, comprising:
retrieving data regarding a campaign from one or more databases accessible by one or more client instances accessible by one or more remote client networks, wherein the campaign comprises one or more campaign-related activities to be performed by each individual of a group;
marking as incomplete the one or more campaign-related activities not performed by respective individuals of the group and marking as complete the one or more campaign-related activities performed by the respective individuals of the group;
determining first subsequent campaign-related content for a first set of individuals in response to determining that the first set of individuals has not engaged with the one or more campaign-related activities;
determining second subsequent campaign-related content for a second set of individuals in response to determining that the second set of individuals has engaged with the one or more campaign-related activities; and
presenting the first subsequent campaign-related content to the first set of individuals and the second subsequent campaign-related content to the second set of individuals based on the determinations.

11. The processor-implemented method of claim 10, wherein engaging with the one or more campaign-related activities comprises selecting a button, watching a video, clicking on a link, submitting a catalog item, submitting an order guide, executing a checklist, signing documentation, taking a survey, uploading documents, or any combination thereof.

12. The processor-implemented method of claim 10, wherein outputting the first subsequent campaign-related content to the first set of individuals comprises sending the first set of individuals a reminder to engage with the one or more campaign-related activities.

13. The processor-implemented method of claim 10, wherein outputting the second subsequent campaign-related content to the second set of individuals comprises assigning a new campaign-related activity, ending the campaign, assigning the second individual to another campaign, triggering a life-cycle event, or any combination thereof.

14. The processor-implemented method of claim 10, wherein completion progress of the one or more campaign-related activities relative to the campaign corresponding to each of the individuals is independent of other completion progress.

15. The processor-implemented method of claim 10, wherein each individual of the group is identified based on trigger data relevant to each corresponding individual.

16. A tangible, non-transitory, machine-readable medium, comprising machine-readable instructions, wherein the machine-readable instructions, when executed by one or more processors cause the one or more processors to:
retrieve data regarding a campaign from one or more databases accessible by one or more client instances accessible by one or more remote client networks, wherein the campaign comprises one or more campaign-related activities to be performed by each individual of a group;
mark as incomplete the one or more campaign-related activities not performed by respective individuals of the group and mark as complete the one or more campaign-related activities performed by respective individuals of the group;
determine first subsequent campaign-related content for a first set of individuals in response to determining that the first set of individuals has not engaged with the one or more campaign-related activities;
determine second subsequent campaign-related content for a second set of individuals in response to determining that the second set of individuals has engaged with the one or more campaign-related activities and
present the first subsequent campaign-related content to the first set of individuals, outputting the second subsequent campaign-related content to the second set of individuals based on the determinations.

17. The tangible, non-transitory, machine-readable medium of claim 16, wherein the campaign-related content comprises one or more campaign items, one or more additional campaign-related activities associated with each individual of the group based on a determination that identification data of each individual of the group satisfies a criteria.

18. The tangible, non-transitory, machine-readable medium of claim 16, wherein engaging with the one or more campaign-related activities comprises selecting a button, watching a video, clicking on a link, submitting a catalog item, submitting an order guide, executing a checklist, signing documentation, taking a survey, uploading documents, or any combination thereof.

19. The tangible, non-transitory, machine-readable medium of claim 16, wherein outputting the first subsequent campaign-related content to the first set of individuals comprises sending the first set of individuals a reminder to engage with the one or more campaign-related activities.

20. The tangible, non-transitory, machine-readable medium of claim 16, wherein outputting the second subsequent campaign-related content to the second set of individuals comprises assigning a new campaign-related activity, ending the campaign, assigning the second set of individuals to another campaign, triggering a life-cycle event, or any combination thereof.
